(19) United States
(12) Patent Application Publication
(10) Pub. No.: US 2013/0094246 A1
(43) Pub. Date: Apr. 18, 2013

(54) BACKLIGHT UNIT AND DISPLAY DEVICE HAVING THE SAME

(71) Applicant: SAMSUNG ELECTRONICS CO., LTD., Suwon-si (KR)

(72) Inventors: Jung Kyun KIM, Yongin-si (KR); Jee Hoon SUNG, Seongnam-si (KR); Jin Hyun CHO, Seoul (KR); Kye Hoon LEE, Suwon-si (KR)

(73) Assignee: SAMSUNG ELECTRONICS CO., LTD., Suwon-si (KR)

(21) Appl. No.: 13/651,869

(22) Filed: Oct. 15, 2012

(30) Foreign Application Priority Data
Oct. 14, 2011 (KR) 10-2011-0105570

(51) Int. Cl. F21V 29/00; G09F 13/18; G09F 13/04

(52) U.S. Cl. 362/613; 362/97.1

(57) ABSTRACT

A backlight unit, a display module and a display device capable of effectively distributing heat inside, the display device including a display panel, a bottom sash disposed at a rear side of the display panel, a plurality of light emitting diodes (LEDs) configured to provide the display panel with light, at least one printed circuit board (PCB) which is disposed at an edge of a front surface of the bottom sash and on which the plurality of LEDs are mounted, and at least one heat radiation sheet mounted on the bottom sash to distribute heat emitted from the plurality of LEDs.

### CROSS-REFERENCE TO RELATED APPLICATION

This application claims priority from Korean Patent Applications No. 2011-0105570, filed on Oct. 14, 2011 in the Korean Intellectual Property Office, the disclosure of which is incorporated herein by reference in its entirety.

### BACKGROUND

1. Field

Apparatuses consistent with exemplary embodiments relate to a display device having a display module capable of uniformly distributing heat concentrated on a particular portion to an entire area of the display device.

2. Description of the Related Art

In recent years, Flat Panel Display devices with their thin thickness, light weight and low power consumption have been increasingly developed as a substitute for a Cathode-ray Tube Displays.

One example of the Flat Panel Display device is a Liquid Crystal Display (LCD) that displays an image using electrical and optical characteristics of liquid crystals.

The LCD is provided with a liquid crystal display panel, which is configured to display an image in an optical manner, and a Back Light Unit (BLU) to provide the liquid crystal display panel with light.

In recent years, as a substitute for a conventional Cold Cathode Fluorescent Lamp (CCFL), a Light Emitting Diode (LED) has mainly been used as a light source of the BLU based on its favorable weight, thickness, power consumption and lifespan.

The LED emits heat along with light. The heat as such increases the temperature of a LED chip, resulting in degradation of the brightness and lifespan of the LED.

In addition, the liquid crystals have a characteristic that the alignment of molecules of liquid crystals is changed by external heat, so the heat emitted by the LED may change the alignment of liquid crystal molecules. In particular, since the LED is disposed at an edge of the LCD panel, the alignment of molecules is different at a part of the panel, so that the image quality represented on the screen is degraded.

### SUMMARY

Therefore, it is an aspect of exemplary embodiments to provide a backlight unit capable of effectively distributing heat inside the backlight, a display module having the same and a display device having the same.

Additional aspects of exemplary embodiments will be set forth in the part in the description which follows and, in part, will be obvious from the description, or may be learned by practice of the disclosure.

In accordance with one aspect of an exemplary embodiment, there is provided a display device comprising: a display panel; a bottom sash disposed at a rear side of the display panel; a plurality of light emitting diodes (LEDs) configured to provide the display panel with light; at least one printed circuit board (PCB) which is disposed at a front surface of the bottom sash and on which the plurality of LEDs are mounted; and at least one heat radiation sheet mounted on the bottom sash to distribute heat emitted from the plurality of LEDs.

The at least one PCB may comprise a first PCB disposed at one from among a left side edge and a right side edge of a front surface of the bottom sash, and the at least one heat radiation sheet comprises a first heat radiation sheet that is disposed between the first PCB and the bottom sash.

The at least one PCB may comprise a second PCB that is disposed at an edge of the front surface of the bottom sash opposite the edge having the first PCB disposed thereon, and the at least one heat radiation sheet may comprise a second heat radiation sheet that is disposed between the second PCB and the bottom sash.

The display device may further comprise a power supply board configured to supply the display panel with power and disposed adjacent to the first PCB at a rear surface of the bottom sash, wherein the first heat radiation sheet has a thermal conductivity higher than a thermal conductivity of the second heat radiation sheet.

The first heat radiation sheet may have a width wider than a width of the second heat radiation sheet such that the first heat radiation sheet has a first thermal conductivity higher than a second thermal conductivity of the second heat radiation sheet.

The at least one PCB may comprise an upper PCB disposed at an upper side edge of a front surface of the bottom sash, and the at least one heat radiation sheet may comprise an upper heat radiation sheet that is disposed between the upper PCB and the bottom sash.

The at least one PCB may comprise a lower PCB disposed at a lower side edge of the front surface of the bottom sash, and the at least one heat radiation sheet may comprise a lower heat radiation sheet that is disposed between the lower PCB and the bottom sash.

The upper heat radiation sheet may have a first thermal conductivity higher than a second thermal conductivity of the lower heat radiation sheet.

The upper heat radiation sheet may have a width wider than a width of the lower heat radiation sheet such that the upper heat radiation sheet has the first thermal conductivity higher than the second thermal conductivity of the lower heat radiation sheet.

The display device may further comprise a power supply board configured to supply the display panel with power and disposed at one from among a left side edge and a right side edge of a rear surface of the bottom sash, wherein the upper heat radiation sheet and the lower heat radiation sheet each have attached one portion that is adjacent to the power supply board and at least one portion that is distant from the power supply board, the at least one portion that is adjacent to the power supply board having a third thermal conductivity higher than a fourth thermal conductivity of the at least one portion that is distant from the power supply board.

The device may further comprise a heat radiation plate disposed between the at least one PCB and the bottom sash to absorb heat that is generated from the at least one PCB.

The at least one heat radiation sheet may be disposed between the at least one PCB and the heat radiation plate.

The at least one heat radiation sheet may be mounted on a rear surface of the bottom sash to correspond to a position of the at least one PCB that is disposed on a front surface of the bottom sash.

The at least one heat radiation sheet may comprise a graphite sheet.

According to another exemplary embodiment, there is provided a device comprising: a display panel configured to display an image; a top sash configured to support a periphery of a front surface of the display panel; a rear cover forming a rear side exterior of the device; a bottom sash disposed at a rear side of the display panel; a power supply board configured to supply the display panel with power and mounted on a rear surface of the bottom sash; a plurality of light emitting diodes (LEDs) configured to provide the display panel with light; a plurality of printed circuit boards (PCBs) which are disposed at a bottom surface of the bottom sash and on which the plurality of LEDs are mounted; and a plurality of heat radiation sheets disposed at a rear side of the plurality of PCBs.

A thermal conductivity of one of the plurality of heat radiation sheets adjacent to the power supply board may be higher than a thermal conductivity of remaining heat radiation sheets.

The thermal conductivities of the plurality of heat radiation sheets may be correspondingly higher at portions of the plurality of heat radiation sheets that are nearer to the power supply board.

According to yet another exemplary embodiment, there is provided a device comprising: a display panel; a top sash disposed at a front side of the display panel and having an opening that allows a portion of the display panel, on which an image is displayed, to be exposed through a front surface of the top sash; a bottom sash which is disposed at a rear side of the display panel and on which the display panel is mounted; at least one printed circuit board (PCB) stacked up in parallel to a bottom surface of the bottom sash and disposed adjacent to a rim of the bottom sash; a plurality of light emitting diodes (LEDs) mounted on the at least one PCB while protruding beyond a surface of the at least one PCB to provide the display panel with light; and at least one heat radiation sheet mounted on the bottom sash while making contact with a front surface of the bottom sash such that the heat emitted from the at least one PCB is distributed, wherein the bottom sash comprises an Electrolytic Galvanized Iron (EGI).

The at least one heat radiation sheet may be disposed between the at least one PCB and the bottom sash.

The at least one heat radiation sheet may be mounted on a rear surface of the bottom sash to correspond to a position of the at least one PCB, which is disposed on the front surface of the bottom sash.

A heat radiation sheet disposed at an upper side of the bottom sash among the at least one heat radiation sheet may have a thermal conductivity higher than a heat radiation sheet disposed at a lower side of the bottom sash among the at least one heat radiation sheet.

The device may further comprise a power supply board configured to supply the display panel with power while being disposed adjacent to one from among a left side edge and a right side edge of the rear surface of the bottom sash, wherein one of the at least one heat radiation sheet which is nearer to the power supply board has a thermal conductivity higher than a thermal conductivity of the other of the at least one heat radiation sheet farther away from the power supply board.

According to yet another exemplary embodiment, there is provided a device comprising: a display panel; a top sash disposed at a front side of the display panel and having an opening that allows a portion of the display panel, on which an image is displayed, to be exposed through a front surface of the top sash; a bottom sash disposed at a rear side of the display panel and comprising a bottom surface and a bottom lateral surface that protrudes from the bottom surface; at least one printed circuit board (PCB) stacked up in parallel to the bottom lateral surface, and disposed adjacent to a rim of the bottom sash; at least one heat sink disposed between the bottom sash and the at least one PCB and comprising a base plate making contact with the bottom surface of the bottom sash and a side plate that is bent from the base plate and is extended to make contact with the bottom lateral side of the bottom sash; a plurality of light emitting diodes (LEDs) mounted on the PCB while protruding from a front surface of the PCB to provide the display panel with light; and at least one heat radiation sheet mounted on the bottom sash while making contact with a front surface of the bottom sash such that the heat emitted from the at least one PCB is distributed, wherein the bottom sash comprises an Electrolytic Galvanized Iron (EGI).

The at least one heat radiation sheet may be disposed between the at least one light emitter and the bottom sash.

The at least one heat radiation sheet may be provided at a rear surface of a portion of the bottom sash, the portion having the at least one light emitter mounted thereon.

The backlight unit may further comprise a heat sink disposed between the at least one light emitter and the bottom sash to radiate the heat generated from the at least one light emitter, wherein the at least one heat radiation sheet is mounted between the heat sink and the bottom sash.

As described above, the heat radiation sheet is mounted at a lower portion of the bottom sash, thereby effectively distributing heat emitted from the light emitting diode.

### BRIEF DESCRIPTION OF THE DRAWINGS

These and/or other aspects of exemplary embodiments will become apparent and more readily appreciated from the following description, taken in conjunction with the accompanying drawings of which:

FIG. 1 is a perspective view illustrating the configuration of a display device according to an exemplary embodiment.

FIG. 2 is a cross-sectional view of the display device of FIG. 1.

FIG. 3 is a view illustrating a bottom sash and a heat radiation sheet of the display device of FIG. 1.

FIG. 4 is a cross-sectional view taken along line A-A of FIG. 3.

FIG. 5 is a perspective view illustrating the configuration of a display device according to another exemplary embodiment.

FIG. 6 is a cross sectional view of the display device of FIG. 5.

FIG. 7A is a view illustrating a bottom sash and a heat radiation sheet of the display device of FIG. 5.

FIG. 7B is a cross sectional view taken along line B-B of FIG. 7A.

FIGS. 8 and 9 are views illustrating alternatives of the bottom sash and the heat radiation sheet of FIG. 7A.

FIG. 10 is a perspective view illustrating the configuration of a display device according to still another exemplary embodiment.

FIG. 11 is a view illustrating a bottom sash and a heat radiation sheet of the display device of FIG. 10.

### DETAILED DESCRIPTION

Reference will now be made in detail to exemplary embodiments, examples of which are illustrated in the accompanying drawings, wherein like reference numerals refer to like elements throughout.

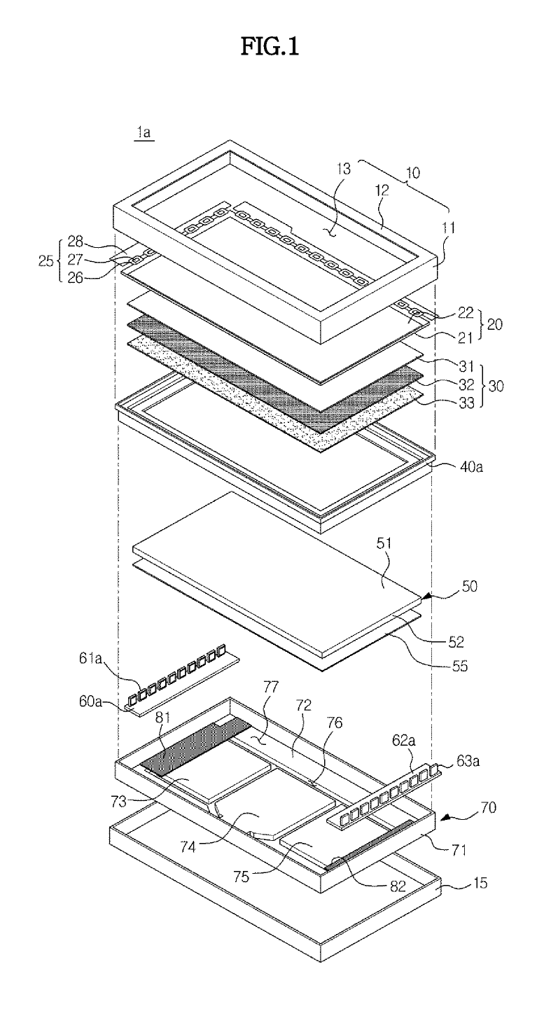

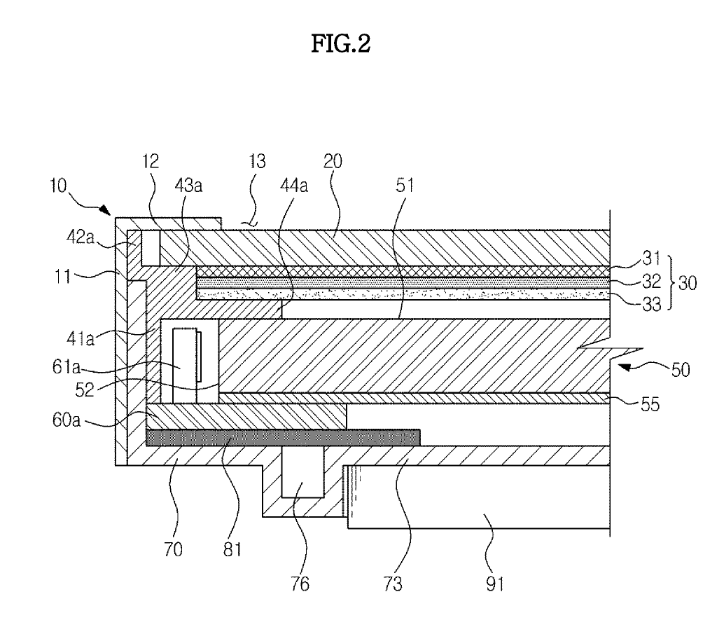

FIG. 1 is a perspective view illustrating the configuration of a display device according to an exemplary embodiment.

Referring to FIG. 1, a display device la includes a display panel 20, a backlight unit disposed at a rear side of the display panel 20 while being spaced apart from the display panel 20, a middle mold 40a configured to support the display panel 20 and the backlight unit while being spaced apart from each other, a top sash 10 disposed at a front surface of the display panel 20, a bottom sash 70 disposed at a rear side of the display panel 20, and heat radiation sheets including a left side heat radiation sheet 81 and a right side heat radiation sheet 82 disposed between the bottom sash 70 and the backlight unit.

A rear cover 15 forming a rear side exterior of the display device la is coupled to the rear side of the bottom sash 70.

The respective parts from the top sash 10 to the bottom sash 70 form a display module. The rear cover 15 is coupled to the display module, thereby completing the assembly of the display device 1a.

The backlight unit includes a plurality of optical sheets 30 disposed at a lower side of the display panel 20, a light guide plate 50 disposed at a lower side of the plurality of optical sheets 30, a reflection sheet 55 disposed while making contact with a lower surface of the light guide plate 50, a plurality of light emitting diodes (LEDs) 61a and 63a configured to provide the light guide plate 50 with light, and printed circuit boards (PCBs) 60a and 62a on which the plurality of LEDs 61a and 63a are mounted.

The plurality of optical sheets 30 includes a protection film 31, a prism film 32, and a diffusion film 33.

The protection film 31 is disposed at an upper side of the prism film 32 to protect the prism film 32 that is sensitive to scratches, such as dusts, etc.

The prism film 32 is formed by having trigonal prisms arranged in a predetermined alignment on an upper surface to collect a light vertically diffused from the diffusion film 33 to a horizontal surface of the display panel 20 that is disposed at an upper side of the prism film 32.

In general, the prism film 32 is implemented using two prism films. A micro-prism formed on each prism film 32 has a predetermined angle.

Most of the light passing through the prism film 32 vertically proceeds to provide uniform brightness distribution.

The diffusion film 33 diffuses the light, which is received from the light guide plate 50, to the display panel 20. To this end, a coating layer is formed on a base plate of the diffusion film 33.

The light guide plate 50 includes acryl based resin, such as Polymethly Methacrylate (PMMA), or polymethylstrene to uniformly provide the diffusion film 33 with light emitted from light emitting diodes 61a and 63a.

The light guide plate 50 is provided at a side end with a light incident surface 52 to which the light emitted from the light emitting diodes 61a an 63a is introduced, a light emission surface 51 which faces the diffusion film 33, and a reflection surface (not shown) provided in parallel to the light emission surface 51.

The reflection sheet 55 is disposed at a lower side of the light guide plate 50 to return the light, which is emitted through the lower surface of the light guide plate 50, to the light guide plate 50 again. The reflection sheet 55 includes plastic material such as polyethylene terephthalate (PET) or polycarbonate.

The plurality of light emitting diodes 61a and 63a which emits light is mounted on the PCBs 60a and 62a, and the PCBs 60a and 62a are configured to apply electric signals to the plurality of light emitting diodes 61a and 63a. According to this exemplary embodiment e, the PCBs 60a and 62a are implemented using a PCB 60a and a PCB 62a provided at a left side edge and a right side edge of the bottom sash 70, respectively. The PCBs 60a and 62a are fixed to the bottom sash 70 through a coupling member, such as a screw, or an adhesion member, such as a double-sided tape.

The plurality of light emitting diodes 61a and 63a are mounted on the surfaces of the PCBs 60a and 62a in a protruding direction to which the light emitting diodes 61a and 63a protrude from the PCBs 60a and 62a. The plurality of light emitting diodes 61a and 63a are spaced apart lengthwise from each other along the PCBs 60a and 62a. The plurality of light emitting diodes 61a and 63a radiates light in a direction vertical to the protruding direction of the light emitting diodes 61a and 63a.

Rear sides of the surfaces of the PCBs 60a and 62a, the surfaces having the plurality of light emitting diodes 61a and 63a mounted thereon, are fixed to a bottom surface 72 of the bottom sash 70. Accordingly, the light emitting diodes 61a and 63a radiate light in a direction vertical to the protruding direction of the light emitting diodes 61a and 63a from the PCBs 60a and 62a.

The light emitting diodes 61a and 63a may include a plurality of light emitting diodes emitting white light, or may include the combination of a plurality of light emitting diodes emitting a red light, a green light, and a blue light.

The display panel 20 includes a thin film transistor substrate 21 on which a thin film transistor is formed, a color filter substrate 22 facing the thin film transistor 21, and a liquid crystal layer (not shown) provided between the thin film transistor substrate 21 and the color filter substrate 22.

The thin film transistor substrate 21 is provided at one side thereof with a driving unit 25 configured to apply a drive signal.

The driving unit 25 includes a flexible printed circuit board (FPCB) 26, a driving chip 27 mounted on the flexible printed circuit board 26, and a circuit board 28 connected opposite to the flexible printed circuit board.

The flexible printed circuit board 26 is implemented through a Chip On Film (COF) in which a chip device is mounted on a base film. However, the FPCB may be implemented through a Tape Carrier Package (TCP) using a Tape Automated Bonding (TAP) or through a Chip On Glass (COG).

The display panel 20 is configured to form a screen by adjusting the alignment of the liquid crystal layer. However, the display panel 20 is classified into a non-emissive device, and displays an image by receiving the light from the backlight unit disposed at the rear side of the display panel 20.

The top sash 10 includes a vessel surrounding the periphery of the display panel 20 and a top side surface 11 bent from an end portion of the vessel 12. The top sash 10 has an opening 13 allowing an effective display area of the display panel 20, on which a screen is display, to be exposed at the entire surface of the top sash 10.

The bottom sash 70 includes the bottom surface 72 on which the backlight unit is mounted and a bottom lateral surface 71 extending while protruding from the circumference of the bottom surface 72 upward.

The heat radiation sheets 81 and 82, the backlight unit including the printed circuit boards 60a and 62a, the middle mold 40a, the optical sheet 30, and the display panel 20 are sequentially mounted on the bottom surface 72 of the bottom sash 70.

An upper rim 42a of the middle mold 40a extends upward such that an outer surface of the upper rim 42a is coplanar with an outer surface of the bottom lateral surface 71 of the bottom sash 70. The upper rim 42a of the middle mold 40a is stepped inward to form a lower rim 41a of the middle mold 40a that extends downward. An outer surface of the lower rim 41 a of the middle mold 40a makes contact with an inner surface of the bottom lateral surface 71 of the bottom sash 70.

A first extension part 43a extending from the upper rim 42a of the middle mold 40a inward supports the periphery of the display panel 20.

A second extension part 44a extending from the first extension part 43a while being stepped inward supports the periphery of the optical sheet 30.

The light emitting diodes 61a and 63a simultaneously emit light and heat. The printed circuit boards 60a and 62a serve to provide the light emitting diodes 61a and 63a with a driving signal while serving to transfer heat generated from the light emitting diodes 61a and 63a to the outside. That is, the PCBs 60a and 62a serve to transfer the heat generated from the LEDs 61a and 63a to the bottom sash 70 through the PCBs 61a and 63a.

In general, the bottom sash includes metal, such as aluminum, that is suitable for radiating the heat emitted from the light emitting diode. However, aluminum has a high unit cost and a low strength. Accordingly, there is a need for a method of manufacturing a bottom sash using an Electrolytic Galvanized Iron (EGI) that has a high strength and a low unit cost.

However, the Electrolytic Galvanized Iron (EGI) has a low thermal conductivity that is not suitable for radiating the heat generated from the light emitting diodes 61a and 63a. If an additional heat radiation device is provided to improve the heat radiation efficiency, the unit cost is increased, and the thickness of the display device is increased.

Accordingly, in order to remove the constraints of the bottom sash including the Electrolytic Galvanized Iron (EGI) and also to provide an enhanced heat radiation efficiency over the conventional aluminum bottom sash, the heat radiation sheets 81 and 82 are mounted on the bottom sash 70.

The heat radiation sheets 81 and 82 are attached to the bottom surface 72 of the bottom sash 70, and the PCBs 60a and 62a are mounted on the heat radiation sheets 81 and 82.

Hereinafter, the heat radiation sheets 81 and 82 mounted on the bottom sash 70 will be described with reference to accompanied drawings.

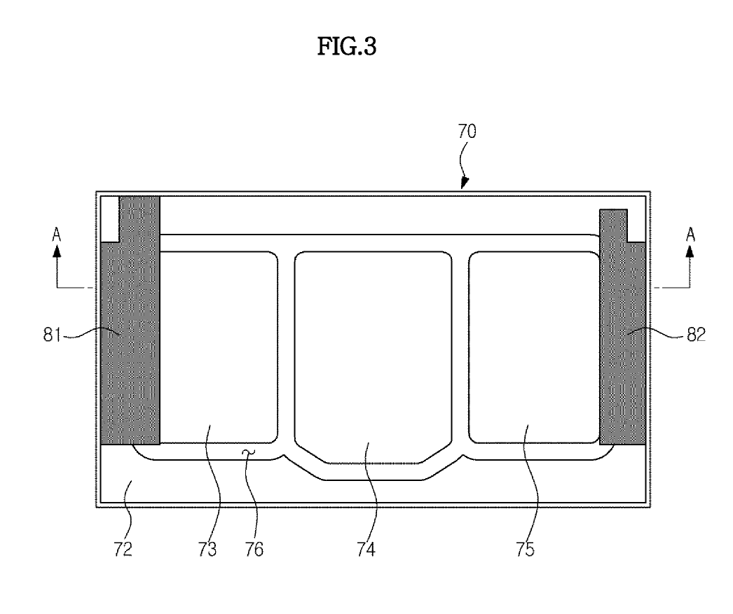

FIG. 3 is a view illustrating a bottom sash and a heat radiation sheet of the display device of FIG. 1.

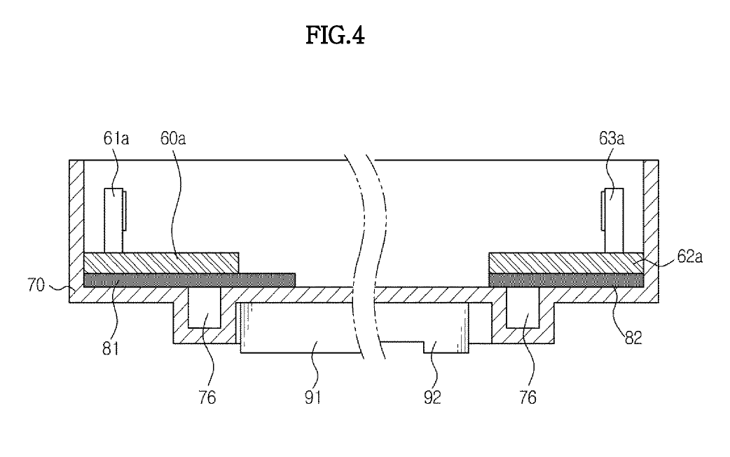

Referring to FIGS. 3 and 4, the bottom surface 72 is protruded to a rear side of the bottom sash 70, thereby forming a beading 76. The beading 76 improves the strength of the bottom sash 70.

The bottom surface 72 of the bottom sash 70 is divided into three portions including a first portion 73, a second portion 74, and a third portion 75 by the beading 76. A power supply board 91 is mounted at a rear side of the first portion 73. An image processing board 92 is mounted at a rear side of the third portion 75. A signal transmission board 93 is mounted at a rear side of the second portion 74.

The power supply board 91 is designed to connect the external power to the display device la, and includes a Switched Mode Power Supply (SMPS). The image processing board 92 represents a main board at which an image signal that is displayed on the display panel (20 in FIG. 1) is generated. The signal transmission board 93 is a board configured to send the display panel 20 the image signal generated from the image processing board 92, and includes a T-CON board.

A board (not shown) configured to supply the light emitting diodes 61a and 63a with a power may be additionally provided at a rear side of the bottom sash 70 or may be included in the power supply board 91.

The left side heat radiation sheet 81 and the right side heat radiation sheet 82 are mounted at a left side edge and a right side edge of the bottom surface 72 of the bottom sash 70, respectively.

The heat radiation sheets 81 and 82 may include material having a high thermal conductivity such that the heat generated from the power supply board 91 and the light emitting diodes 61a and 63a is radiated. The heat radiation sheets 81 and 82 may include graphite material.

The graphite is one of the allotropes of carbon. The graphite is strong against heat and corrosion, and has a high thermal conductivity, and is thus suitable for material of the heat radiation sheets 81 and 82.

The heat radiation sheets 81 and 82 each has one surface that is coated with an adhesive material, and is attached to the bottom surface 72 of the bottom sash 70. Alternatively, the heat radiation sheets 81 and 82 may be attached to the bottom sash 70 by use of an adhesion member such as a double sided member.

The opposite surface of the one surface of the heat radiation sheets 81 and 82, and the surface having the bottom sash 70 attached thereto, may include a PET film for an electrical insulation.

Although not shown, the heat resistance sheets 81 and 82 may have a step according to the shape of the beading 76 such that the heat resistance sheets 81 and 82 come into close contact with the bottom sash 70.

The PCBs 60a and 62a are disposed on the entire surfaces of the heat radiation sheets 81 and 82, respectively. The PCBs 60a and 62a may be provided in a predetermined width and a predetermined length depending on the bottom surface 72.

Each of the heat radiation sheets 81 and 82 are provided in a rectangular shape. However, each of the heat radiation sheets 81 and 82 may be provided at an upper side thereof with a cut-off portion. A coupling member for coupling various components mounted on the front side of the bottom sash 70 may pass through the cut-off portion. Alternatively, according to another aspect of an exemplary embodiment, the heat radiation sheets 81 and 82 may be formed with a through hole allowing a coupling member to pass therethrough.

The left side radiation sheet 81 is disposed adjacent to the first portion 73, and the power supply board 91 mounted at the rear side of the first portion 73 is adjacent to the left side radiation sheet 81. Accordingly, the left side heat radiation sheet 81 needs to dissipate the heat emitted from the power supply board 91 as well as the heat emitted from the light emitting diodes 61a and 63a.

Meanwhile, the right side heat radiation sheet 82 is adjacent to the image processing board 92 disposed at a rear side of the second portion 74, but the image processing board 92 does not emit a large amount of heat.

The heat conductivity of the heat radiation sheets 81 and 82 each becomes higher as the width of heat radiation sheets 81 and 82 each becomes wider. Accordingly, the left side heat radiation sheet 81 needing to perform more dissipation is provided in a width larger than that of the right side heat radiation sheet 82.

Alternatively, the thicker the heat radiation sheets 81 and 82 are, the higher the heat conductivities of the heat radiation sheets 81 and 82 are. According to another aspect of an exemplary embodiment, the left side heat radiation sheet 81 may be provided with a thickness that is thicker than that of the right side heat radiation sheet 82.

Since the heat radiation sheets 81 and 82 are provided in the form of a thin sheet, the thicknesses of the heat radiation sheets 81 and 82 do not affect the height or the thickness of the PCBs 60a and 62a.

The heat radiation sheets 81 and 82 having a high thermal conductivity disperse the heat generated from the light emitting diodes 61a and 63a and from the power supply board 91 over the entire surface of the bottom sash 70.

The display panel (20 in FIG. 1) has a characteristic that the alignment of the molecules of the liquid crystals is changed by heat. Accordingly, if the heat is concentrated on a particular area, the alignment of the molecules is not uniform over the entire area of the display panel, thereby degrading the image quality.

However, according to this exemplary embodiment, the heat radiation sheets 81 and 82 having a high thermal conductivity are disposed to dissipate the emitted heat all over the entire area of the display panel, thereby preventing heat from being concentrated on a particular area.

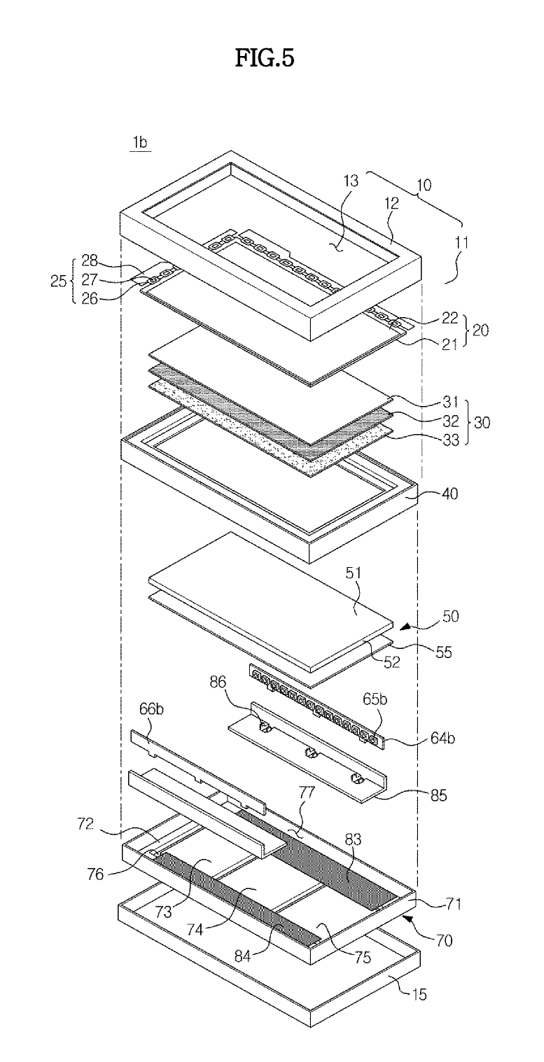

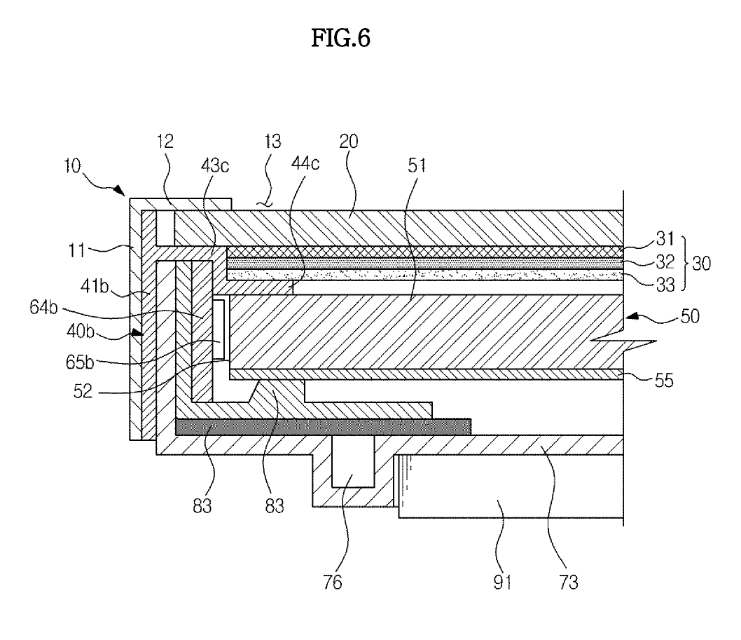

FIG. 5 is a perspective view illustrating the configuration of a display device according to another exemplary embodiment. FIG. 6 is a cross-sectional view of the display device of FIG. 5.

In the following description, details of parts identical to those of the previous exemplary embodiment will be omitted in order to avoid redundancy.

Referring to FIGS. 5 and 6, a display device 1b includes the display panel 20, a backlight unit disposed at a rear side of the display panel 20 while being spaced apart from the display panel 20, a middle mold 40b configured to support the display panel 20 and the backlight unit while being spaced apart from each other, the top sash 10 disposed at a front surface of the display panel 20, the bottom sash 70 disposed at a rear side of the display panel 20, and the rear cover 15 coupled to the rear side of the bottom sash 70 to form an rear side exterior of the display device 1b.

The backlight unit includes the plurality of optical sheets 30 disposed at a lower side of the display panel 20, the light guide plate 50 disposed at a lower side of the plurality of optical sheets 30, the reflection sheet 55 disposed while making contact with a lower surface of the light guide plate 50, a plurality of light emitting diodes (LEDs) 65b and 67b configured to provide the light guide plate 50 with light, printed circuit boards (PCBs) 64b and 66b on which the plurality of LEDs 65b and 67b are mounted.

A heat sink 85 is mounted on the bottom surface 72 of the bottom sash 70 between the bottom sash 70 and the PCBs 64b and 66b to radiate the heat generated from the PCBs 64b and 66b.

Heat radiation sheets including an upper side radiation sheet 83 and a lower side radiation sheet 84 having a high thermal conductivity are disposed between the heat sink 85 and the bottom sash 70.

The heat sink 85 includes a base plate along with a side plate that is bent from the base plate and is extended upward. The base plate is provided with a mounting unit 86 to which the PCBS 64b and 66b are mounted.

The PCBs 64b and 66b are implemented using two PCBs, which are disposed at an upper side edge and a lower side edge of the bottom sash 70, respectively. The PCBs 64b and 66b each has a protrusion at a position corresponding to the mounting unit 86 of the heat sink 85. When the protrusion is inserted into the mounting unit 86, the heat sink 85 having the PCBs 64b and 66b mounted thereon is fixed to the bottom sash 70 through a coupling member, such as a screw, or an adhesive member, such as a double sided tape.

Different from the heat radiation sheets according to the previous exemplary embodiment, the heat radiation sheets 83 and 84 do not extend to the both edges. Accordingly, the heat radiation sheets 83 and 84 do not have a cut-off portion. However, if the heat radiation sheets 83 and 84 are configured to extend to the both edges, the heat radiation sheets 83 and 84 may have a cut-off portion.

If the heat sink 85 is not provided, only a small area of the PCBs 64b and 66b makes contact with the heat radiation sheets 83 and 84, thereby failing to transfer a great amount of heat to the heat radiation sheets 83 and 84 in dissipating heat.

Accordingly, the side plate of the heat sink 85 makes contact with the rear surface of the PCBs 64b and 66b to absorb the heat emitted from the PCBs 64b and 66b and to transfer the absorbed heat to the heat radiation sheets 83 and 84 through the base plate of the heat sink 85. In this regard, even though the heat radiation sheets 83 and 84 are disposed on the bottom surface 72, the heat emitted from the PCBs 64b and 66b is properly dissipated by the heat sink 85.

The plurality of light emitting diodes 65b and 67b are mounted on surfaces of the PCBs 64b and 66b in a protruding direction to which the light emitting diodes 65b and 67b protrude from the PCBs 64b and 66b. The rear sides of the surfaces of the PCBs 64b and 66b, the surfaces having the plurality of light emitting diodes 65b and 67b mounted thereon, come into close contact with the side plate of the heat sink 85. That is, the PCBs 64b and 66b are vertically mounted on the heat sink 85 in the same manner as the bottom lateral surface 71 of the bottom sash 70.

Accordingly, the plurality of light emitting diodes 65b and 67b radiate light in the same direction as the protruding direction of the light emitting diodes 65b and 67b.

A rim 41b of the middle mold 40b extends vertically such that an inner surface of the rim 41b makes contact with an outer surface of the bottom lateral surface 71 of the bottom sash 70. The rim 41b of the middle mold 40b extends inward, thereby forming a first extension part 43c. An upper surface of the first extension part 43c supports the periphery of the display panel 20. A lower surface of the first extension part 43c makes contact with an end portion of the bottom lateral surface 71 of the bottom sash 70.

A second extension part 44c extends from the first extension part 43c while being stepped inward. An upper surface of the second extension part 44c supports the periphery of the optical sheet 30. [0122]

A portion from the rim 41b of the middle mold 40b to the step formed by the first extension part 43c and the second extension part 44b supports the bottom lateral surface 71 of the bottom sash 70, the side plate of the heat sink 85 and the PCBs 64b and 66b while accommodating the bottom lateral surface 71 of the bottom sash 70, the side plate of the heat sink 85 and the PCBs 64b and 66b.

The heat radiation sheets 83 and 84 are attached to the bottom surface 72 of the bottom sash 70. The heat sink 85 having the PCBs 64b and 66b mounted thereon is coupled to the heat radiation sheets 83 and 84.

Hereinafter, the description will be made in relation to the heat radiation sheets 83 and 84 mounted on the bottom sash 70.

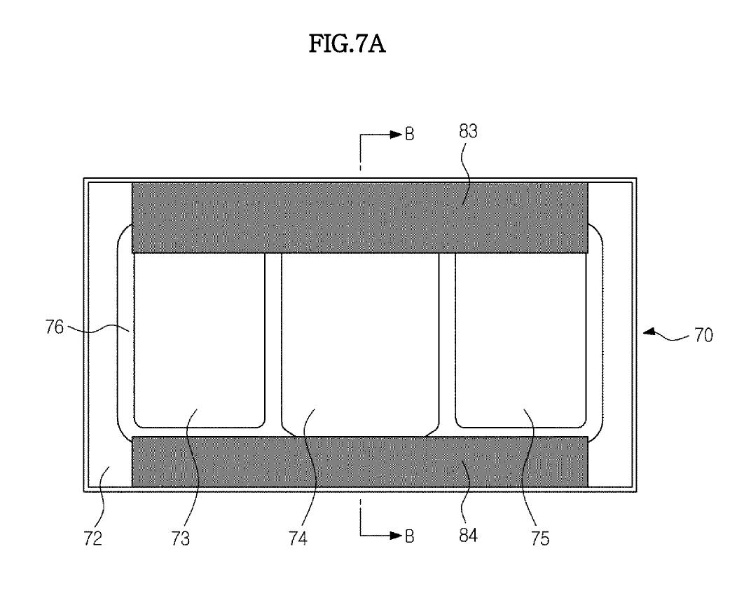

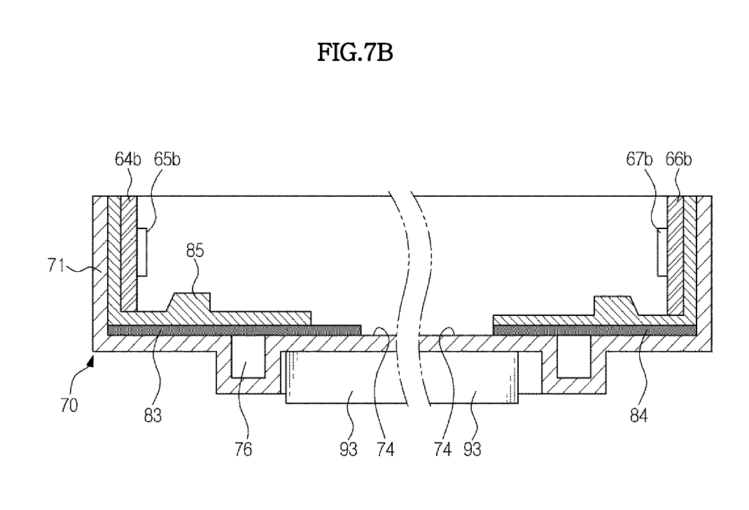

FIG. 7A is a view illustrating a bottom sash and a heat radiation sheet of the display device of FIG. 5. FIG. 7B is a cross-sectional view taken line B-B of FIG. 7A.

Referring to FIG. 7A, the beading 76 is formed on the bottom surface 72 of the bottom sash 70. The bottom surface 72 of the bottom sash 72 is divided into three portions including the first portion 73, the second portion 74, and the third portion 75 by the beading 76. The power supply board 91 is mounted at a rear side of the first portion 73. The image processing board 92 is mounted at a rear side of the third portion 75. The signal transmission board 93 is mounted at a rear side of the second portion 74.

The upper side heat radiation sheet 83 and the lower side heat radiation sheet 84 are mounted at an upper side edge and a lower side edge of the bottom surface 72 of the bottom sash 70, respectively.

Referring to the FIG. 7B, the heat radiation sheets 83 and 84 are attached to the bottom surface 72 of the bottom sash 70, and the heat sink 85 having the PCBs 64b and 66b mounted thereon is disposed on the heat radiation sheets 83 and 84. The left side and the right side of FIG. 7B represent the upper side of the bottom sash and the lower side of the bottom sash, respectively.

As the view shown in FIG. 7B is obtained by cutting through the middle of the bottom sash 70, the second portion 74 formed by the beading 76 and the signal transmission board 93 are shown in FIG. 7B.

The air, when the temperature of the air is increased, rises and, when the temperature of air decreases, the air falls, thereby forming convection current. The hot air heated inside the display device 1b stays at an upper side of the display device 1b due to the convection, and thus the temperature of the upper side of the display device 1b is increased.

Accordingly, the upper side heat radiation sheet 83 disposed at the upper side needs to have a thermal conductivity higher than that of the lower side heat radiation sheet 84. As shown in FIG. 7B, the upper side heat radiation sheet 83 is wider than that of the lower side heat radiation sheet 84, thereby allowing the upper side heat radiation sheet 83 to have a higher thermal conductivity exceeding the lower side heat radiation sheet 84.

Alternatively, according to another aspect of an exemplary embodiment, the upper side heat radiation sheet 83 may be thicker than that of the lower side heat radiation sheet 84, thereby allowing the upper side heat radiation sheet 83 to have a higher thermal conductivity exceeding the lower side heat radiation sheet 84.

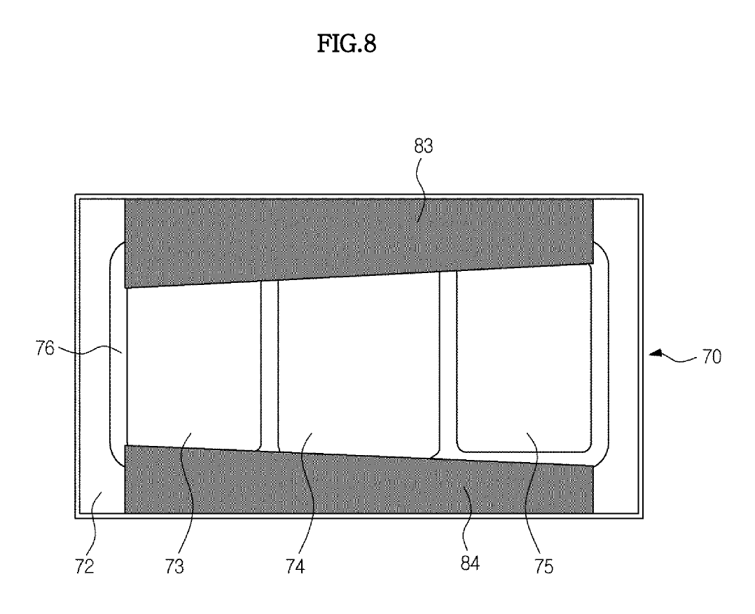

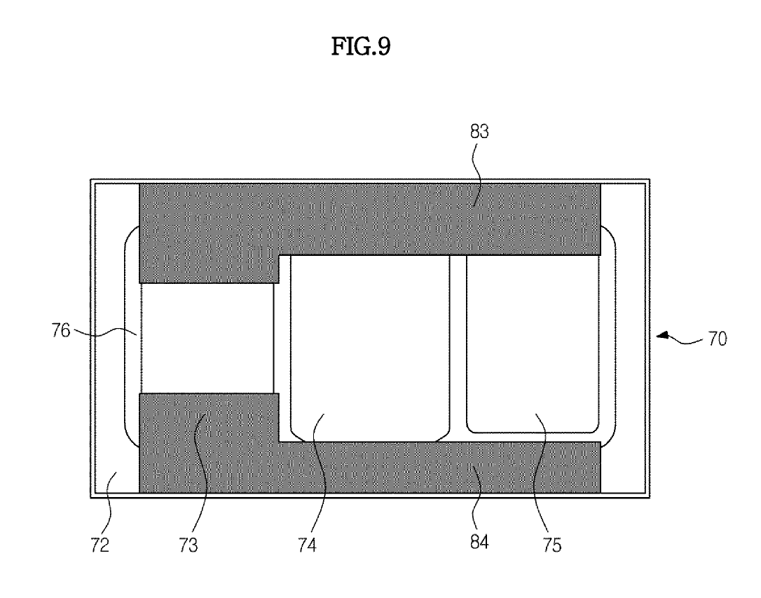

FIGS. 8 and 9 are views illustrating alternatives of the bottom sash and the heat radiation sheet of FIG. 7A.

Referring to FIGS. 8 and 9, the power supply board 91 is mounted on the rear side of the first portion 73 that is formed by the beading 76. The temperature at a side of the first portion 73 of the bottom sash 70, which has the power supply board 91 and the LEDs 65b and 67b emitting heat, is higher than the temperature at a side of the third portion 75, which has the LEDs 65b and 67b emitting heat.

Accordingly, the heat radiation efficiency needs to be enhanced near the first portion.

Referring to FIG. 8, the heat radiation sheets 83 and 84 are increasingly wider at portions thereof that are closer to the first portion 73. Accordingly, the thermal conductivity of the heat radiation sheets 83 and 84 is increased while nearer the first portion 73.

Referring to FIG. 9, a predetermined region of the heat radiation sheets 83 and 84 covering the first portion is provided with an increased width. In this manner, the heat emitted from the power supply board 91 and the light emitting diodes 65b and 67b is effectively dissipated by the heat radiation sheets 83 and 84.

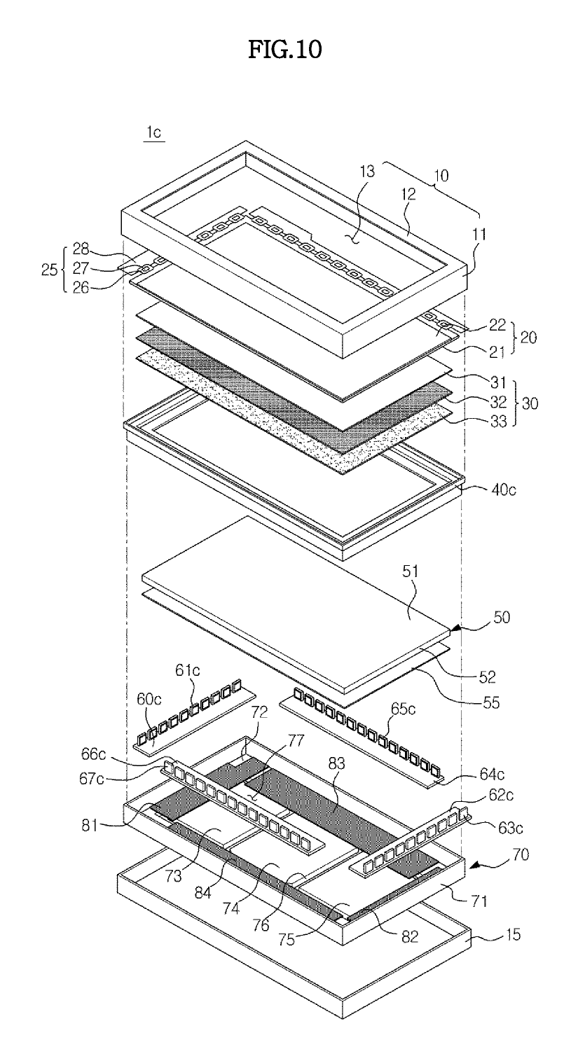

FIG. 10 is a perspective view illustrating the configuration of a display device according to still another exemplary embodiment.

Referring to FIG. 10, the display device 1c includes the display panel 20, a backlight unit disposed at a rear side of the display panel 20 while being spaced apart from the display panel 20, a middle mold 40c configured to support the display panel 20 and the backlight unit while being spaced apart from each other, the top sash 10 disposed at a front surface of the display panel 20, the bottom sash 70 disposed at a rear side of the display panel 20, and the heat radiation sheets 81, 82, 83 and 84 disposed between the bottom sash 70 and the backlight unit.

The rear cover 15 is coupled to the rear side of the bottom sash 70 to form a rear side exterior of the display device 1c.

The backlight unit includes the plurality of optical sheets 30 disposed at a lower side of the display panel 20, the light guide plate 50 disposed at a lower side of the plurality of optical sheets 30, the reflection sheet 55 disposed while making contact with a lower surface of the light guide plate 50, a plurality of light emitting diodes (LEDs) 61c, 63c, 65c and 67c configured to provide the light guide plate 50 with light, and printed circuit boards (PCBs) 60c, 62c, 64c and 66c on which the plurality of LEDs 61c, 63c, 65c and 67c are mounted.

Printed circuit boards (PCBs) 60c, 62c, 64c and 66c having the plurality of LEDs 61c, 63c, 65c and 67c mounted thereon are provided four edges of the bottom sash 70, respectively.

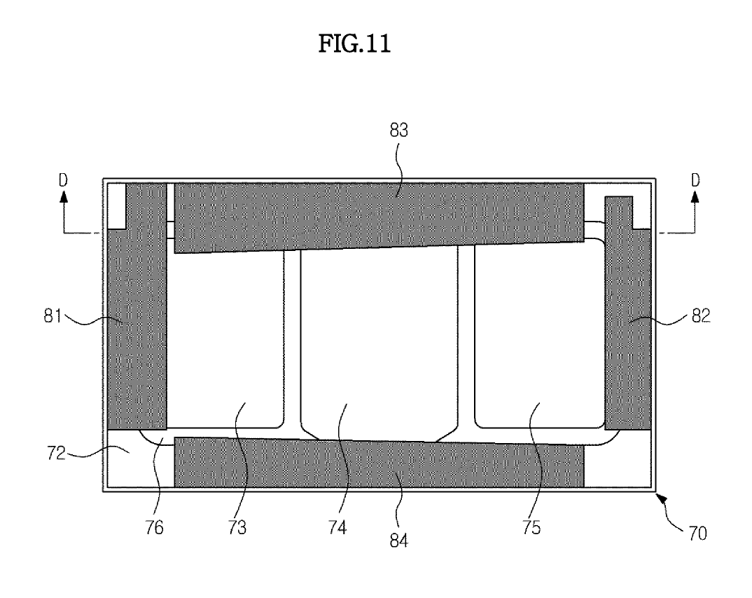

FIG. 11 is a view illustrating a bottom sash and a heat radiation sheet of the display device of FIG. 10.

Referring to FIG. 11, the heat radiation sheets 81, 82, 83 and 84 include the upper side heat radiation sheet 83, the lower side heat radiation sheet 84, the left side heat radiation sheet 81 and the right side heat radiation sheet 82.

The power supply board 91 emitting heat is provided at the rear side of the first portion 73 that is formed by the beading 76. That is, heat is concentrated on the left side of the bottom sash 70 and thus heat is intensively emitted from the left side of the bottom sash 70.

Accordingly, the left side heat radiation sheet 81 has a width larger than that of the right side heat radiation sheet 82. In addition, each of the upper side heat radiation sheet 83 and the lower side heat radiation sheet 84 is provided with an increasing width while going from the right portion to the left portion of the upper side heat radiation sheet 83 and the lower side heat radiation sheet 84.

The left side radiation sheet 81 and the left portion of the upper side heat radiation sheet 83 have a larger width, and thus, have a higher thermal conductivity. Accordingly, even if heat is intensely emitted from the left side as compared to the right side, the heat is effectively dispersed all over the entire surface of the bottom sash 70.

Although not shown in the drawings, according to another exemplary embodiment, a printed circuit board having a plurality of LEDs mounted thereon may be disposed at one of the four edges of the bottom sash 70.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A device comprising:
a display panel;
a bottom sash disposed at a rear side of the display panel;
a plurality of light emitting diodes (LEDs) configured to provide the display panel with light;
at least one printed circuit board (PCB) which is disposed at a front surface of the bottom sash and on which the plurality of LEDs are mounted; and
at least one heat radiation sheet mounted on the bottom sash to distribute heat emitted from the plurality of LEDs.

2. The device of claim 1, wherein the at least one PCB comprises a first PCB disposed at one from among a left side edge and a right side edge of the front surface of the bottom sash, and
the at least one heat radiation sheet comprises a first heat radiation sheet that is disposed between the first PCB and the bottom sash.

3. The device of claim 2, wherein the at least one PCB comprises a second PCB that is disposed at an edge of the front surface of the bottom sash opposite the edge having the first PCB disposed thereon, and
the at least one heat radiation sheet comprises a second heat radiation sheet that is disposed between the second PCB and the bottom sash.

4. The device of claim 3, further comprising a power supply board configured to supply the display panel with power and disposed adjacent to the first PCB at a rear surface of the bottom sash,
wherein the first heat radiation sheet has a thermal conductivity higher than a thermal conductivity of the second heat radiation sheet.

5. The device of claim 4, wherein the first heat radiation sheet has a width wider than a width of the second heat radiation sheet such that the first heat radiation sheet has a first thermal conductivity higher than a second thermal conductivity of the second heat radiation sheet.

6. The device of claim 1, wherein the at least one PCB comprises an upper PCB disposed at an upper side edge of the front surface of the bottom sash, and
the at least one heat radiation sheet comprises an upper heat radiation sheet that is disposed between the upper PCB and the bottom sash.

7. The device of claim 6, wherein the at least one PCB comprises a lower PCB disposed at a lower side edge of the front surface of the bottom sash, and
the at least one heat radiation sheet comprises a lower heat radiation sheet that is disposed between the lower PCB and the bottom sash.

8. The device of claim 7, wherein the upper heat radiation sheet has a first thermal conductivity higher than a second thermal conductivity of the lower heat radiation sheet.

9. The device of claim 8, wherein the upper heat radiation sheet has a width wider than a width of the lower heat radiation sheet such that the upper heat radiation sheet has the first thermal conductivity higher than the second thermal conductivity of the lower heat radiation sheet.

10. The device of claim 7, further comprising a power supply board configured to supply the display panel with power and disposed at one from among a left side edge and a right side edge of a rear surface of the bottom sash,
wherein the upper heat radiation sheet and the lower heat radiation sheet each have at least one portion that is adjacent to the power supply board and at least one portion that is distant from the power supply board, the at least one portion that is adjacent to the power supply board having a third thermal conductivity higher than a fourth thermal conductivity of the at least one portion that is distant from the power supply board.

11. The device of claim 1, further comprising a heat radiation plate disposed between the at least one PCB and the bottom sash to absorb heat that is generated from the at least one PCB.

12. The device of claim 11, wherein the at least one heat radiation sheet is disposed between the at least one PCB and the heat radiation plate.

13. The device of claim 1, wherein the at least one heat radiation sheet is mounted on a rear surface of the bottom sash to correspond to a position of the at least one PCB that is disposed on the front surface of the bottom sash.

14. The device of claim 1, wherein the at least one heat radiation sheet comprises a graphite sheet.

15. A device comprising:
a display panel configured to display an image;
a top sash configured to support a periphery of a front surface of the display panel;
a rear cover forming a rear side exterior of the device;
a bottom sash disposed at a rear side of the display panel;
a power supply board configured to supply the display panel with power and mounted on a rear surface of the bottom sash;
a plurality of light emitting diodes (LEDs) configured to provide the display panel with light;
a plurality of printed circuit boards (PCBs) which are disposed at a bottom surface of the bottom sash and on which the plurality of LEDs are mounted; and
a plurality of heat radiation sheets disposed at a rear side of the plurality of PCBs.

16. The device of claim 15, wherein a thermal conductivity of one of the plurality of heat radiation sheets adjacent to the power supply board is higher than a thermal conductivity of remaining heat radiation sheets.

17. The device of claim 15, wherein thermal conductivities of the plurality of heat radiation sheets are correspondingly higher at portions of the plurality of heat radiation sheets that are nearer to the power supply board.

18. A device comprising:
a display panel;
a top sash disposed at a front side of the display panel and having an opening that allows a portion of the display panel, on which an image is displayed, to be exposed through a front surface of the top sash;
a bottom sash which is disposed at a rear side of the display panel and on which the display panel is mounted;
at least one printed circuit board (PCB) stacked up in parallel to a bottom surface of the bottom sash and disposed adjacent to a rim of the bottom sash;
a plurality of light emitting diodes (LEDs) mounted on the at least one PCB while protruding beyond a surface of the at least one PCB to provide the display panel with light; and
at least one heat radiation sheet mounted on the bottom sash while making contact with a front surface of the bottom sash such that the heat emitted from the at least one PCB is distributed,
wherein the bottom sash comprises an Electrolytic Galvanized Iron (EGI).

19. The device of claim 18, wherein the at least one heat radiation sheet is disposed between the at least one PCB and the bottom sash.

20. The device of claim 18, wherein the at least one heat radiation sheet is mounted on a rear surface of the bottom sash to correspond to a position of the at least one PCB, which is disposed on the front surface of the bottom sash.

21. The device of claim 18, wherein a heat radiation sheet disposed at an upper side of the bottom sash among the at least one heat radiation sheet has a thermal conductivity higher than a heat radiation sheet disposed at a lower side of the bottom sash among the at least one heat radiation sheet.

22. The device of claim 18, further comprising a power supply board configured to supply the display panel with power while being disposed adjacent to one from among a left side edge and a right side edge of the rear surface of the bottom sash,
wherein one of the at least one heat radiation sheet which is nearer to the power supply board has a thermal conductivity higher than a thermal conductivity of the other of the at least one heat radiation sheet farther away from the power supply board.

23. A device comprising:
a display panel;
a top sash disposed at a front side of the display panel and having an opening that allows a portion of the display panel, on which an image is displayed, to be exposed through a front surface of the top sash;
a bottom sash disposed at a rear side of the display panel and comprising a bottom surface and a bottom lateral surface that protrudes from the bottom surface;
at least one printed circuit board (PCB) stacked up in parallel to the bottom lateral surface, and disposed adjacent to a rim of the bottom sash;
at least one heat sink disposed between the bottom sash and the at least one PCB and comprising a base plate making contact with the bottom surface of the bottom sash and a side plate that is bent from the base plate and is extended to make contact with the bottom lateral side of the bottom sash;
a plurality of light emitting diodes (LEDs) mounted on the PCB while protruding from a front surface of the PCB to provide the display panel with light; and
at least one heat radiation sheet mounted on the bottom sash while making contact with a front surface of the bottom sash such that the heat emitted from the at least one PCB is distributed,
wherein the bottom sash comprises an Electrolytic Galvanized Iron (EGI).

24. The device of claim 23, wherein the at least one heat radiation sheet is disposed between the at least one heat sink and the bottom sash.

25. The device of claim 23, wherein the at least one heat radiation sheet is mounted on a rear surface of the bottom sash to correspond to a position of the at least one heat sink.

26. A backlight unit comprising:
a light guide plate;
at least one light emitter configured to radiate light to a lateral side of the light guide plate;
a bottom sash which is disposed at a rear side of the light guide plate and on which the at least one light emitter is mounted; and
at least one heat radiation sheet mounted on the bottom sash.

27. The backlight unit of claim 26, wherein the at least one heat radiation sheet is disposed between the at least one light emitter and the bottom sash.

28. The backlight unit of claim 26, wherein the at least one heat radiation sheet is provided at a rear surface of a portion of the bottom sash, the portion having the at least one light emitter mounted thereon.

29. The backlight unit of claim 26, further comprising a heat sink disposed between the at least one light emitter and the bottom sash to radiate the heat generated from the at least one light emitter,
wherein the at least one heat radiation sheet is mounted between the heat sink and the bottom sash.
